(19) United States
(12) Patent Application Publication
(10) Pub. No.: US 2012/0242905 A1
(43) Pub. Date: Sep. 27, 2012

(54) INPUT SWITCHING DEVICE

(75) Inventors: Yoshifumi INOUE, Osaka (JP); Masazumi YAMADA, Osaka (JP)

(73) Assignee: Panasonic Corporation, Osaka (JP)

(21) Appl. No.: 13/312,988

(22) Filed: Dec. 6, 2011

(30) Foreign Application Priority Data
Mar. 24, 2011 (JP) 2011-065569
Nov. 7, 2011 (JP) 2011-243021

(51) Int. Cl. H04N 5/268

(52) U.S. Cl. 348/705; 348/E05.057

(57) ABSTRACT

An input switching device is provided that includes an output decision device, an input switching device, and a switching command device. The output decision device is connected to an input component and configured to determine whether an external device is ready to output a signal to the input component. The input switching device is arranged between the input and an output component. The input switching device switches to the input component when the output decision device has determined that the external device is ready to output a signal to the input component. The switching command device is arranged between the output decision device and the input switching device. The switching command device is configured to instruct a video display device to receive a signal from the input switching device when the output decision device has determined that the external device is ready to output a signal to the input component.

### CROSS-REFERENCE TO RELATED APPLICATIONS

This application claims priority under 35 U.S.C. §119 to Japanese Patent Application No. 2011-065569, filed on Mar. 24, 2011 and Japanese Patent Application No. 2011-243021, filed Nov. 7, 2011. The entire disclosure of Japanese Patent Application No. 2011-065569 and Japanese Patent Application No. 2011-243021 are hereby incorporated herein by reference.

### BACKGROUND

1. Technical Field

The present invention relates to an input switching device connected by high-definition multimedia interface (hereinafter referred to as “HDMI”) with a plurality of source devices. In particular, the present relates to a method for controlling an input selector which can select a source device as the input destination for a digital signal such as video.

2. Background Information

The HDMI standard has come into widespread use in recent years as an interface standard for connecting a video device and an audio device, mainly in the field of consumer video and audio devices. HDMI is an interface that allows the transmission of uncompressed video data and audio data, etc., between two devices. HDMI allows data transmission in one direction, from one device to another. Devices defined in HDMI include the source (hereinafter referred to as “source device”), the sink (hereinafter referred to as “sink device”), and the repeater (hereinafter referred to as “repeater device”). The source device is a device that allows signals to be sent out. The sink device is a device that allows signals to be received. The repeater device is disposed between these two other devices. The repeater device allows signals to be received and sent. The repeater device can have a configuration comprising a plurality of signal input components and one signal output component, or a configuration comprising one signal input component and a plurality of signal output components. The repeater device can comprise a selector function for source device or sink device, etc. A device such as this is also called an input switching device. Rather than letting inputted signals pass through, the repeater device has the capability of both a sink device and a source device combined into one device, and can first decode received HDMI signals into video signals, audio signals, control signals, and so forth, and then convert the decoded signals back into HDMI signals for output.

Also, the consumer electronics control (hereinafter referred to as “CEC”) standard goes along with the HDMI standard. This CEC standard allows the operation of one device to be controlled through user manipulation of another device, and information about a specific device to be acquired and reported on by exchanging control information (hereinafter referred to as CEC commands) between devices connected by HDMI. High-Definition Multimedia Interface Specification Version 1.1, 2004 (hereinafter referred to as “Non-Patent Literature 1”) and Enhanced Extended Display Identification Data Standard Release A, Revision 1 VESA, 2002 (hereinafter referred to as “Non-Patent Literature 2”) ( ) disclose details about the HDMI standard.

Recently, there has been growing popularity of home theater systems in which a sink device (such as a television set), a source device (such as a Blu-ray player, a DVD player, or an STB), and an audio reproduction device (such as an AV amplifier) are connected using an interface that conforms to the HDMI standard disclosed in Non-Patent Literatures 1 and 2. The AV amplifier has a function that allows audio to be outputted from a speaker connected to the AV amplifier, on the basis of an audio signal sent from a television receiver or an audio signal sent from a DVD player.

Some television sets are equipped with a plurality of HDMI input terminals, so that video and audio can be reproduced and outputted by selecting a specific HDMI input from among the plurality of HDMI inputs by manipulation of the sink device itself. Also, some AV amplifiers are equipped with a plurality of HDMI input terminals, so that a specific HDMI input terminal can be selected from among the plurality of HDMI inputs, and an HDMI signal received from a player connected to the specific HDMI input terminal of the television set can be sent out again. It is known that selection of the AV amplifier input terminal here can be accomplished by manipulation of the AV amplifier itself, or by a CEC command that includes information about the signal input path from a television or player.

For instance, in Japanese Laid-Open Patent Application 2009-141537 (hereinafter referred to as “Patent Literature 1”), a method is disclosed with which a television produces and displays an input switching OSD that includes input terminal information about an AV amplifier by acquiring information about the AV amplifier input terminal from the AV amplifier through a CEC command. With this method, the user can select a specific input terminal of the AV amplifier on the television.

Thus, with a conventional AV amplifier, a specific input terminal can be selected from among a plurality of HDMI inputs by control through a CEC command from connected devices by user manipulation of the AV amplifier itself or by user manipulation on a connected player or television set.

### SUMMARY

However, it has been discovered that with the method in Patent Literature 1, both the AV amplifier and the television use CEC commands are unique to each vendor, and operation is premised on using a television together with an AV amplifier that can interpret these CEC commands, but if either one of the devices is incompatible with this setup, the effect disclosed in Patent Literature 1 cannot be obtained.

Also, if the method in Patent Literature 1 is combined with a conventional device that is incompatible with CEC commands that can be interpreted as above, one way to switch the HDMI input of the AV amplifier is to use automatic switching by a CEC command issued by the player at the start of video output or at the start of reproduction. However, it has been discovered that if the player is not compatible with CEC commands, the AV amplifier will have to be manipulated directly in order to switch the HDMI input of the AV amplifier, and even if power is switched on to the player connected to the HDMI input on the unselected side of the AV amplifier and vide output commenced, a problem is that the video and audio of the player connected to the HDMI input on the unselected side cannot be seen or heard unless the AV amplifier input is switched and the television input is switched, which is inconvenient to the user.

In view of this, and in order to solve the above-mentioned problems encountered in the past, one object of the technology disclosed herein is to provide an AV amplifier (that is, an input switching device) in which nothing new needs to be added as long as the television set is compatible with CEC commands of the standard that is essential to CEC command compatibility, and even if a player connected to the HDMI input on the unselected side of the AV amplifier is incompatible with CEC commands, the AV amplifier input switching and the television input can be automatically switched to a player that is powered up, merely by turning on the power to the player, so that the video and audio reproduced by that player can be seen and heard.

In accordance with one aspect of the technology disclosed herein, an input switching device is provided that includes an output decision device, an input switching device, and a switching command device. The output decision device is connected to an input component and configured to determine whether an external device is ready to output a signal to the input component. The input switching device is arranged between the input and an output component. The input switching device switches to the input component when the output decision device has determined that the external device is ready to output a signal to the input component. The switching command device is arranged between the output decision device and the input switching device. The switching command device is configured to instruct a video display device to receive a signal from the input switching device when the output decision device has determined that the external device is ready to output a signal to the input component.

These and other objects, features, aspects and advantages of the technology disclosed herein will become apparent to those skilled in the art from the following detailed description, which, taken in conjunction with the annexed drawings, discloses a preferred and example embodiments of the present invention.

### BRIEF DESCRIPTION OF DRAWINGS

Referring now to the attached drawings which form a part of this original disclosure:

FIG. 1 is a block diagram of a video and audio reproduction system that includes an input switching device pertaining to an embodiment;

FIG. 2 is a flowchart of determining the connection of an external device connected to the input switching device pertaining to an embodiment, and the start of video output; and

FIG. 3 is a sequence diagram of the operation of input switching in the input switching device pertaining to an embodiment.

### DETAILED DESCRIPTION OF THE PREFERRED EMBODIMENT

One embodiment of the input switching device will now be explained with reference to the drawings. It will be apparent to those skilled in the art from this disclosure that the following description of the embodiment is provided for illustration only and not for the purpose of limiting the present technology as defined by the appended claims and their equivalents.

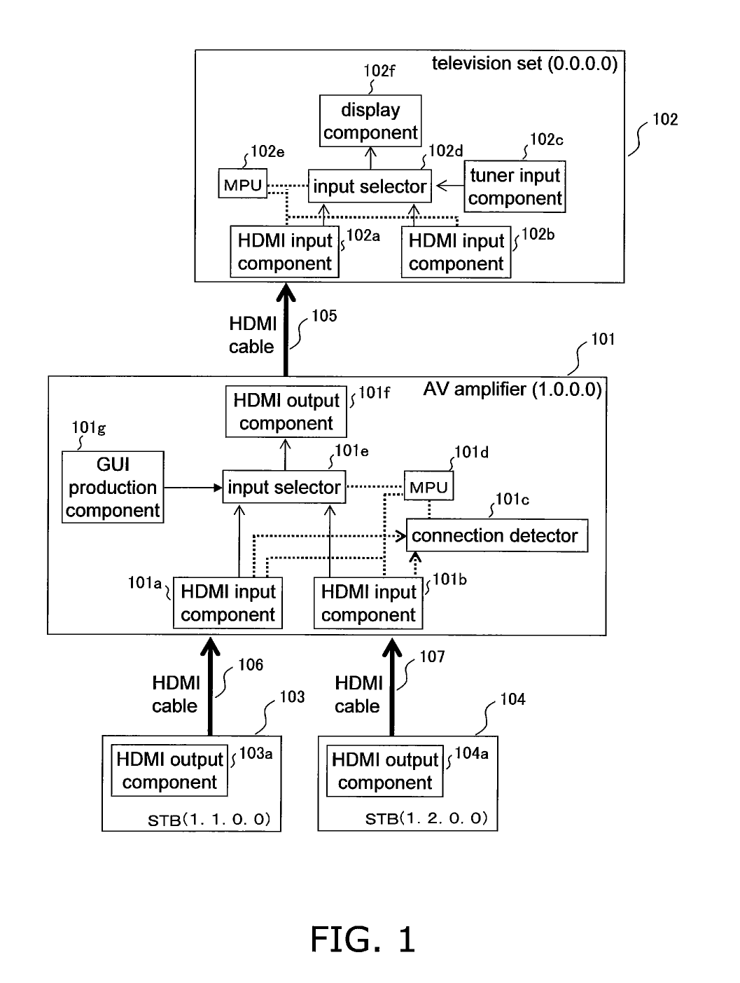

FIG. 1 is a block diagram of a video and audio reproduction system that includes an input switching device pertaining to an embodiment.

A video and audio reproduction system comprises an AV amplifier 101, a television set 102, an STB 103, and an STB 104. An HDMI output component 101f of the AV amplifier 101 connects to an HDMI input component 102a of the television set 102 with an HDMI cable 105. HDMI input components 101a and 101b of the AV amplifier are connected to an HDMI output component 103a of the STB 103 with an HDMI cable 106, and to an HDMI output component 104a of the STB 104 with an HDMI cable 107. With this constitution, the AV amplifier 101 receives video or other signals from the STB 103 through the HDMI input component 101a, and resends these received signals from the HDMI output component 101f. The television set 102 receives signals from the AV amplifier 101 through the HDMI input component 102a, and can display the received video and so forth.

### Configuration of AV Amplifier

The AV amplifier 101 is one example of an input switching device. The television set 102 is one example of a video display device. The STBs 103 and 104 are one example of external devices.

The AV amplifier 101 comprises the HDMI input components 101a and 101b, a connection detector 101c, the HDMI output component 101f, a GUI production component 101g, an input selector 101e, and an MPU 101d. In this embodiment, the physical address of the AV amplifier 101 is assumed to be 1.0.0.0.

The HDMI input component 101a and the HDMI input component 101b are examples of a second input component respectively. The connection detector 101c is an example of an output decision device. An MPU 101d is one example of a switching command device. The input selector 101e is one example of an input switching device. The HDMI output component 101f is one example of an output component.

The MPU 101d controls the input selector 101e, the HDMI input components 101a and 101b, and the HDMI output component 101f, and also controls CEC commands.

The input selector 101e selects the HDMI input component 101a or 101b, encodes video, audio, and control signals decoded from Transition Minimized Differential Signaling (TMDS) signals, or video, audio, and control signals of the GUI production component 101g, into TMDS signals, and resends these from the HDMI output component 101f.

The connection detector 101c monitors +5 V power signals inputted to each of the HDMI input components 101a and 101b, and if it finds this signal, it detects that the STB 103 and the STB 104 are connected to the HDMI input components 101a and 101b, respectively. Further, the connection detector 101c actually executes reception control of TMDS signals, and detects the start of TMDS signal reception when the connected STB 103 starts to output a signal including a video signal. Consequently, the connection detector 101c can detect that the STB 103 is in a state in which an output signal can be outputted.

### Configuration of Television Set

The television set 102 is made up of HDMI input components 102a and 102b, a tuner input component 102c, an input selector 102d, a display component 102f, and an MPU 102e.

The input selector 102d displays video on the display component 102f by selecting either the HDMI input component 102a or 102b or the tuner input component 102c. That is, when the input selector 102d has selected the HDMI input component 102a, video sent out from the AV amplifier 101 connected to the HDMI input component 102a is displayed on the display component 102f. When the input selector 102d has selected the tuner input component 102c, video received by the tuner input component 102c is displayed on the display component 102f, and audio is outputted from a built-in speaker (not shown).

The MPU 102e performs control of at least CEC commands.

### Configuration of STB

The STB 103 comprises the HDMI output component 103a. The STB 104 comprises the HDMI output component 104a. The HDMI output component 103a of the STB 103 is connected to the HDMI input component 101a of the AV amplifier 101 through the HDMI cable 106. The HDMI output component 104a of the STB 104 is connected to the HDMI input component 101b of the AV amplifier 101 through the HDMI cable 107.

The STB 103 and the STB 104 first output a +5 V power signal when video and audio signals are outputted, after which they recognize from a hot plug signal from the AV amplifier 101 that the AV amplifier 101 is in a state in which reception is possible, and then start outputting video, audio, and control signals encoded as TMDS signals.

### Operation of AV Amplifier

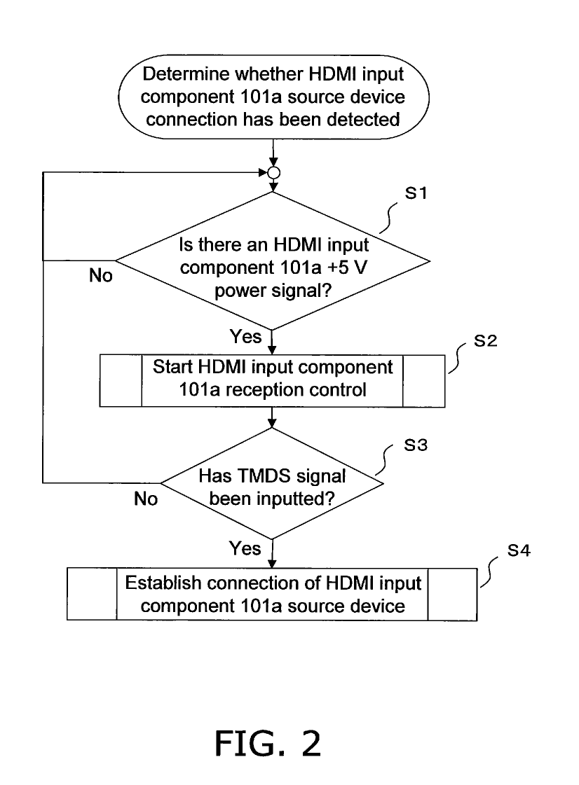

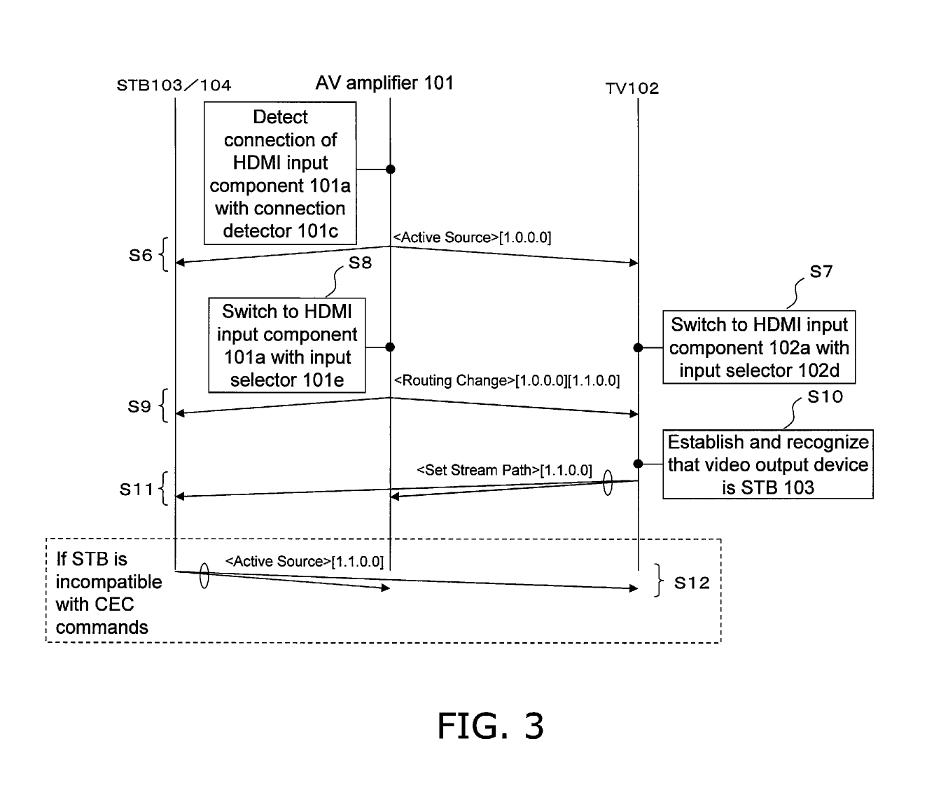

Next, we will describe the operation by which the AV amplifier 101 detects the connection and the start of video output of the STB 103 and automatically switches the input of the television set 102. The same applies to the STB 104, so the STB 104 will not be described. FIG. 2 is a flowchart of determining the connection of the STB connected to the AV amplifier, and the start of video output. FIG. 3 is a sequence diagram of the operation of input switching in the AV amplifier.

First, the connection detector 101c detects the +5 V power signal that the STB 103 outputs through the HDMI cable 106, and thereby detects whether or not the STB 103 is connected (S1). Once the connection of the STB 103 has been detected by the connection detector 101c, the HDMI input component 101a is put in a state in which it can receive a TMDS signal from the STB 103 (S2). The connection detector 101c detects whether or not the TMDS signal from the STB 103 has been inputted to the HDMI input component 101a (S3). Once the input of the TMDS signal from the STB 103 has been detected, the connection detector 101c determines that the STB 103 is in a state in which signals can be outputted (S4). The above operation establishes that the STB 103 is connected to the HDMI input component 101a. The connection detector 101c may use detection of a +5 V power signal to determine that the STB 103 is in a state in which signals can be outputted, without the processing of S2 and S3 being performed.

Once it has thus been established that the STB 103 is in a state that allows TMDS signal output, the MPU 102e issues a CEC command <Active Source>[1.0.0.0] to switch the input of the television set 102 connected to the AV amplifier 101 (S6). Once the television set 102 receives the CEC command <Active Source>[1.0.0.0], the input destination is switched to the HDMI input component 102a to which the AV amplifier 101 is connected (S7). At this point, the video outputted by the AV amplifier itself is displayed on the television set 102.

Then, the AV amplifier 101 automatically switches the input of the AV amplifier itself to the HDMI input component 101a to which the STB 103 is connected (S8). Consequently, the MPU 101d decodes the TMDS signal received from the STB 103 into video, audio, and control signals, again encodes these into a TMDS signal, and starts retransmission to the television set 102. At this point, the video outputted by the STB 103 is displayed on the television set 102. That is, the television set 102 can reproduce the video even though the STB 103 is not compatible with CEC commands.

Then, the AV amplifier 101 issues a CEC command <Routing Change>[1.0.0.0][1.1.0.0], and notifies that the output device for the video and audio signals that are seen and heard is the STB 103 (S9). Once the television set 102 has received the CEC command <Routing Change>[1.0.0.0][1.1.0.0], it is established that the output device for the video and audio signals that are seen and heard is the STB 103. After this, the television set 102 issues a CEC command <Set Stream Path>[1.1.0.0] (S11). Consequently, if the STB 103 is incompatible with CEC commands, a CEC command <Active Source>[1.1.0.0] is issued (S12). Thus, it is also possible, just as in the past, for the television set 102 to be in a state in which control between devices by CEC commands is properly performed, where what is being manipulated is an output device for video currently being displayed.

The AVC amplifier 101 allows the input selector of the input switching device to be automatically switched to a source device (such as a player) connected to the input switching device disclosed herein above, once the video output has started for the player.

With the above disclosed constitution, and with the input switching device disclosed herein above, there is no need to introduce anything new into a player or television set, and even if a player is incompatible with the CEC commands, merely switching on the power to that player will automatically switch the input of the television and the AV amplifier (input switching device), allowing the video and audio reproduced by the player incompatible with the CEC commands to be seen and heard, which improves convenience for the user.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the input switching device.

The term “configured” as used herein to describe a component, section, or part of a device includes hardware and/or software that is constructed and/or programmed to carry out the desired function.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The terms of degree such as “substantially”, “about” and “approximately” as used herein means a reasonable amount of deviation of the modified term such that the end result is not significantly changed.

While only one embodiment has been chosen to illustrate the present invention, it will be apparent to those skilled in the art from this disclosure that various changes and modifications can be made herein without departing from the scope of the invention as defined in the appended claims. For example, the number, size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing description of the embodiment according to the present invention is provided for illustration only, and not for the purpose of limiting the invention as defined by the appended claims and their equivalents.

### INDUSTRIAL APPLICABILITY

With the AV amplifier (input switching device) pertaining to the present invention, when viewing is performed with a television set connected to a main device and an STB connected to a main device, the power merely needs to be switched on to the STB to start HDMI output, and the user does not need to do any input switching of the television set or the AV amplifier. Also, there is no need to newly define CEC commands unique to a vendor, and since the AV amplifier and television set inputs are automatically switched even if the STB is incompatible with CEC commands, and the video and audio of the STB can start being seen and heard, an optimal viewing state can be provided in a system that makes use of CEC commands in a home theater system.

What is claimed is:

1. An input switching device including at least one input component connected to an external device and an output component connected to a video display device, the external device being configured to output a signal to the video display device, the input switching device comprising:
an output decision device connected to the at least one input component and configured to determine whether the external device is ready to output a signal to the at least one input component;
an input switching device arranged between the at least one input component and the output component, the input switching device switching to the at least one input component when the output decision device has determined that the external device is ready to output a signal to the at least one input component; and
a switching command device arranged between the output decision device and the input switching device, the switching command device being configured to instruct the video display device to receive a signal from the input switching device when the output decision device has determined that the external device is ready to output a signal to the at least one input component.

2. The input switching device according to claim 1, wherein
the output decision device is configured to determine that the external device is ready to output a signal to the at least one input component once the output decision device has detected that the external device is connected to the at least one input component and once the output decision device has received from the external device a TMDS signal that includes at least a color signal.

3. The input switching device according to claim 1, wherein
the switching command device is configured to instruct the video display device by issuing a command.
